(19) United States
(12) Patent Application Publication
(10) Pub. No.: US 2016/0138772 A1
(43) Pub. Date: May 19, 2016

(54) VEHICULAR LAMP

(71) Applicants: KOITO MANUFACTURING CO., LTD., Minato-ku, Tokyo (JP); TOYOTA JIDOSHA KABUSHIKI KAISHA, Toyota-shi, Aichi-ken (JP)

(72) Inventors: Yasushi SATO, Shizuoka-shi (JP); Yuji NORITAKE, Toyota-shi (JP)

(73) Assignees: KOITO MANUFACTURING CO., LTD., Tokyo (JP); TOYOTA JIDOSHA KABUSHIKI KAISHA, Toyota-shi, Aichi-ken (JP)

(21) Appl. No.: 14/898,634

(22) PCT Filed: Jun. 17, 2014
(86) PCT No.: PCT/IB2014/001087

§ 371 Date: Dec. 15, 2015

(30) Foreign Application Priority Data
Jun. 18, 2013 (JP) 2013-127561

(51) Int. Cl. F21S 8/10; F21V 8/00

(52) U.S. Cl. CPC F21S 48/2243; G02B 6/0075; G02B 6/0046; G02B 6/0036

(57) ABSTRACT

A vehicular lamp includes a plurality of light sources (7); a first lens (8) with an incident surface (11) upon which light emitted from the light sources (7) is incident and an emission surface (12) from which an incident light from the incident surface (11) is emitted; and a second lens (9) with a light incident surface (15) upon which the light emitted from the emission surface (12) of the first lens (8) is incident and a light emission surface (16) from which an incident light from the light incident surface (15) is emitted. A reflective portion (13) that internally reflects the incident light from the incident surface (11) toward the emission surface (12) is formed on the first lens (8), and a diffusion processing portion (15a) that diffuses light is formed on the light incident surface (15) of the second lens (9).

### BACKGROUND OF THE INVENTION

1. Field of the Invention

The invention relates to a vehicular lamp.

2. Description of Related Art

Typically in a vehicular lamp, a lamp unit including a semiconductor light-emitting device as a light source is arranged inside of a lamp casing formed by a cover and a lamp housing. Also, a vehicular lamp in which a lamp unit includes two lenses that function as light guides to guide light in a predetermined direction, and is configured such that light emitted from a semiconductor light-emitting device is guided by the lenses and radiated toward the outside, is known (see FIG. 6 of Published Japanese Translation of PCT application No. 2008-543004 (JP-A-2008-543004), for example).

The vehicular lamp described in JP-A-2008-543004 is provided with a first lens having a reflective surface that internally reflects light, and a second lens arranged adjacent to the first lens. This vehicular lamp is configured such that light emitted from a plurality of light sources is incident upon the first lens (i.e., strikes the first lens).

The light that strikes the first lens is internally reflected by the reflective surface of the first lens, and as a result the light path changes so that the light strikes the second lens from which it is then emitted from a light emission surface of the second lens and radiated toward the outside.

With the vehicular lamp in which a light guide such as that described in JP-A-2008-543004 is used, the light emitted from each light source is emitted from the light emission surface having a predetermined area, so if the luminance of the light emitted from each portion of the light emission surface is different, the emitted light may be uneven, and luminescent unevenness may end up occurring.

In particular, when a light-emitting diode (LED) is used as the light source, luminescent unevenness may occur more easily because a light-emitting diode is a highly directional light source.

### SUMMARY OF THE INVENTION

The invention thus provides a vehicular lamp capable of reducing the occurrence of luminescent unevenness.

A first aspect of the invention relates to a vehicular lamp that includes a plurality of light sources; a first lens with an incident surface upon which light emitted from the light sources is incident formed on one end portion, and an emission surface from which an incident light from the incident surface is emitted formed on the other end portion; and a second lens with a light incident surface upon which the light emitted from the emission surface of the first lens is incident formed on one end portion, and a light emission surface from which an incident light from the light incident surface is emitted formed on the other end portion. A reflective portion that internally reflects the incident light from the incident surface toward the emission surface is formed on the first lens, and a diffusion processing portion that diffuses light is formed on the light incident surface of the second lens.

Accordingly, the light that is emitted from the emission surface of the first lens and that is incident upon (i.e., that strikes) the light incident surface of the second lens is diffused by the diffusion processing portion and emitted from the light emission surface.

An area of the light emission surface may be smaller than an area of the light incident surface.

Accordingly, the light diffused by the second lens is narrowed so the luminous flux density increases.

The reflective portion may include curved reflective surfaces and steps.

Accordingly, the diffusion angle of the light internally reflected by the reflective portion can be made larger.

A reflective coating may be provided on an outer surface of the reflective portion.

Accordingly, the reflection efficiency of the light in the reflective portion increases.

The light sources may emit light upward. Also, a lower surface of the first lens may be formed as the incident surface, and be positioned opposing the light sources. A rear surface of an upper end portion of the first lens may be formed as the emission surface. The reflective portion may be formed on the first lens, in a position in front of the emission surface. The second lens may be arranged to a rear of the first lens. A front surface of the second lens may be formed as the light incident surface, and be positioned opposing the emission surface. A rear surface of the second lens may be formed as the light emission surface. An upper surface and a lower surface of the second lens may be inclined so as to gradually come closer together toward the rear. In this case, the reflective portion may diffuse light in a lateral direction of the vehicular lamp, and the diffusion processing portion may diffuse light in a vertical direction of the vehicular lamp.

According to the invention, light incident upon the second lens is diffused by the diffusion processing portion, and then emitted from the light emission surface, so the occurrence of luminescent unevenness of the light radiated to the outside is able to be reduced.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic sectional view of a vehicular lamp according to one example embodiment of the invention;

FIG. 2 is a perspective view of a lamp unit;

FIG. 3 is an enlarged vertical sectional view of a reflective portion;

FIG. 4 is an enlarged horizontal sectional view of the reflective portion; and

FIG. 5 is a side view illustrating a light path in a lamp unit.

### DETAILED DESCRIPTION OF EMBODIMENTS

Hereinafter, example embodiments of the vehicular lamp of the invention will be described with reference to the accompanying drawings.

In the example embodiments described below, the vehicular lamp according to the invention is applied to a tail lamp. Accordingly, a direction in which light is radiated from the vehicular lamp to the outside is defined as a rearward direction in the example embodiments. The scope of application of the invention is not limited to a tail lamp. That is, the invention may be widely applied to a variety of vehicular lamps such as a headlamp, a clearance lamp, a turn signal lamp, a stop lamp, a daytime running lamp, a cornering lamp, a hazard lamp, a position lamp, a back lamp, a fog lamp, or a combination lamp in which these are combined.

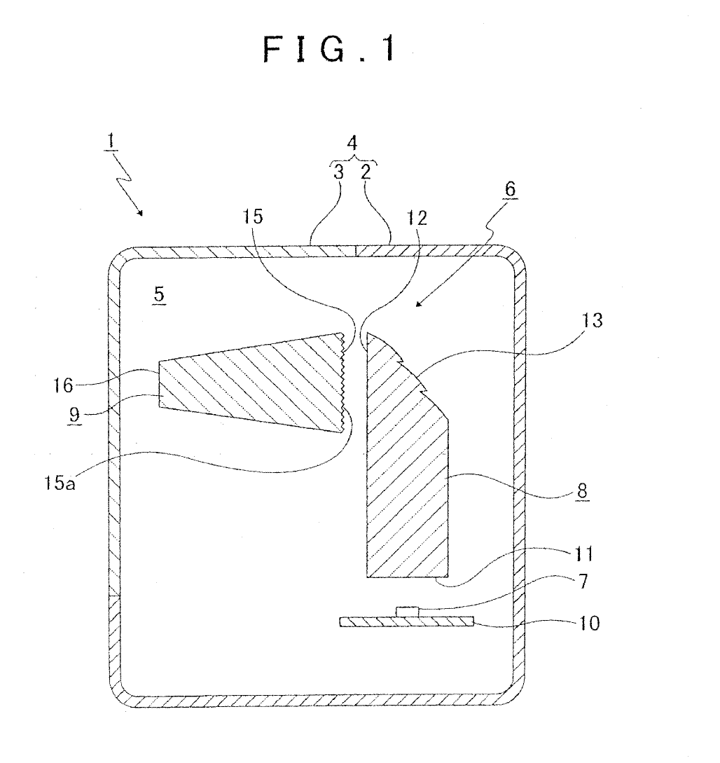

A vehicular lamp 1 is provided on both left and right end portions of a rear end portion of a vehicle body. The vehicular lamp 1 includes a lamp housing 2 that has a recessed portion that is open toward the rear, and a cover 3 that closes off the opening of the lamp housing 2 (see FIG. 1). The lamp housing 2 and the cover 3 together form a lamp casing 4, and an internal space of this lamp casing 4 is formed as a lamp chamber 5.

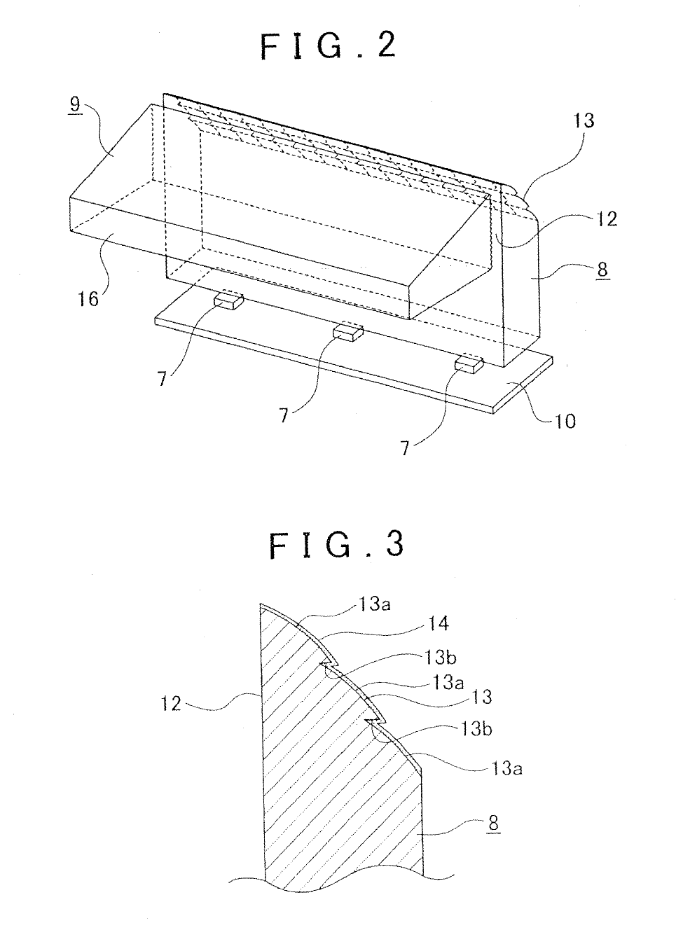

A lamp unit 6 is arranged in the lamp chamber 5. The lamp unit 6 includes a plurality of light sources 7, a first lens 8, and a second lens 9 (see FIGS. 1 and 2).

The light sources 7 are mounted separated from one another laterally on a circuit board 10. These light sources 7 are arranged below the first lens 8 and emit light upward, for example. Light-emitting diodes (LEDs), for example, are used as the light sources 7. Because light-emitting diodes are used as the light sources 7, highly directional light is emitted from the light sources 7.

The circuit board 10 is attached to a heat sink, not shown, arranged in the lamp chamber 5. Therefore, heat generated when the light sources 7 are driven is removed to outside of the lamp casing 4 by the heat sink.

The first lens 8 is a light guide, and is formed in a horizontally long shape that is thin in a front-back direction. A lower surface of the first lens 8 is formed as an incident surface 11, and this incident surface 11 is positioned opposing the light sources 7. A rear surface of an upper end portion of the first lens 8 is formed as an emission surface 12. Light is emitted rearward from this emission surface 12.

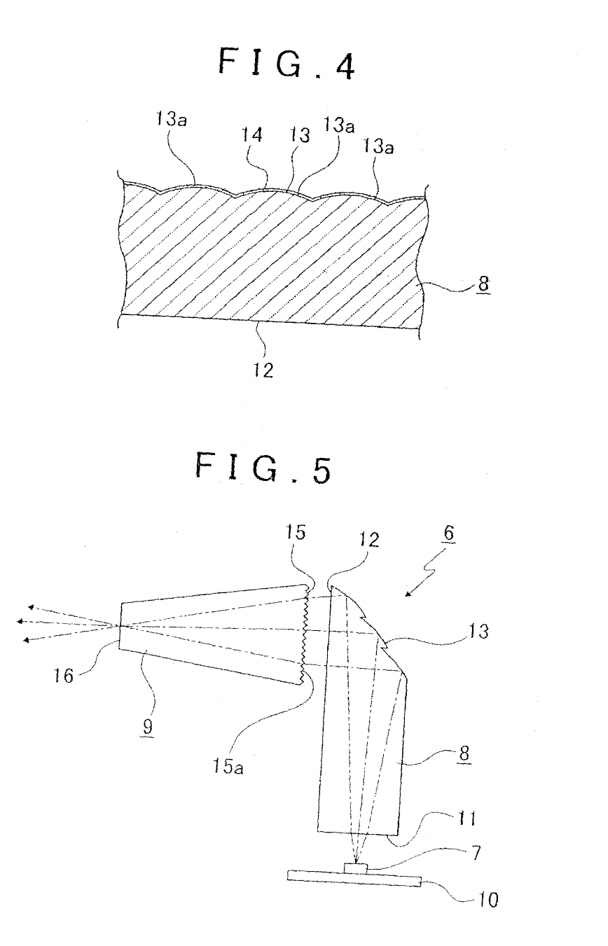

A reflective portion 13 is formed on the first lens 8, in a position in front of emission surface 12. This reflective portion 13 is formed by reflective surfaces 13a that are gently curved so as to protrude outward, being lined up vertically and laterally. In the reflective portion 13, the reflective surfaces 13a and steps 13b that face substantially downward alternate in a continuous fashion in the vertical direction (see FIG. 3), and the reflective surfaces 13a are continuous in the lateral direction (see FIG. 4).

The reflective surfaces 13a serve to internally reflect light, as well as to diffuse light, particularly in the lateral direction.

A reflective coating 14 is provided on an outer surface of the reflective portion 13 (see FIGS. 3 and 4). The reflective coating 14 is formed by aluminum vapor deposition, for example.

The second lens 9 is a light guide, and is formed in a horizontally long shape that is thin in a up-down direction, and is arranged to the rear of the first lens 8 (see FIGS. 1 and 2). An upper surface and a lower surface of the second lens 9 are inclined so that they gradually come closer to one another toward the rear, such that the vertical thickness becomes thinner toward the rear.

A front surface of the second lens 9 is formed as a light incident surface 15. This light incident surface 15 is positioned opposing the emission surface 12 of the first lens 8. A diffusion processing portion 15a formed by a plurality of grains is formed on the light incident surface 15. The diffusion processing portion 15a serves to diffuse light, particularly in the vertical direction.

A rear surface of the second lens 9 is formed as a light emission surface 16. The vertical thickness of the second lens 9 becomes thinner toward the rear as described above, so the area of the light emission surface 16 is smaller than the area of the light incident surface 15.

Next, the path of light emitted from the light sources 7 in the lamp unit 6 structured as described above will be described (see FIG. 5).

When light is emitted from the light sources 7, the emitted light enters the inside of the first lens 8 from the incident surface 11 and reaches the reflective portion 13. At this time, some of the light is internally reflected by both front and back surfaces of the first lens 8 and is guided to the reflective portion 13.

The light that reaches the reflective portion 13 is internally reflected by the reflective surfaces 13a, and consequently, the path of the light changes such that the light heads toward the emission surface 12. At this time, the light that is internally reflected by the reflective surfaces 13a is diffused, particularly in the lateral direction. Also, because the reflective coating 14 is provided on the outer surface of the reflective portion 13, the light is reflected with high efficiency at the reflective portion 13 and heads toward the emission surface 12.

The light that is internally reflected by the reflective portion 13 is emitted from the emission surface 12 and enters the inside of the second lens 9 from the light incident surface 15. At this time, the incident light from the light incident surface 15 is diffused, particularly in the vertical direction, by the diffusion processing portion 15a.

Some of the light that has entered the inside of the second lens 9 from the light incident surface 15 is internally reflected by both upper and lower surfaces of the second lens 9, and emitted rearward from the light emission surface 16, after which it passes through the cover 3 and is radiated to the outside.

Just as described above, in the vehicular lamp 1, the diffusion processing portion 15a that diffuses light is formed on the light incident surface 15 of the second lens 9, so the light that enters the second lens 9 is diffused and emitted from the light emission surface 16, thus enabling the occurrence of luminescent unevenness of the light radiated to the outside to be reduced.

Also, the reflective surfaces 13a that serves to diffuse light are formed on the reflective portion 13 of the first lens 8, so luminescent unevenness of the light radiated to the outside is able to be reduced even more.

Further, the diffusion processing portion 15a formed by the plurality of grains is formed on the light incident surface 15 of the second lens 9, so when the inside of the vehicular lamp 1 is viewed from the outside, the reflective portion 13 of the first lens 8 on which the step 13b is formed is not easily visible, so the appearance of the vehicular lamp 1 is able to be improved.

Also, with the second lens 9, the area of the light emission surface 16 is smaller than the area of the light incident surface 15. Therefore, the light diffused by the second lens 9 is narrowed so the luminous flux density increases. As a result, luminescent unevenness is able to be reduced even more.

Still further, the reflective portion 13 has the step 13b, and the reflective surfaces 13a are curved, so the diffusion angle of the light internally reflected by the reflective portion 13 can be made larger, enabling luminescent unevenness to be reduced even more.

In addition, the reflective coating 14 is provided on the outer surface of the reflective portion 13, so the reflection efficiency of the light in the reflective portion 13 increases, and as a result, the use efficiency of the light emitted from the light sources 7 is able to be improved.

1-6. (canceled)

7. A vehicular lamp comprising:
a plurality of light sources;
a first light guide with an incident surface upon which light emitted from the light sources is incident formed on one end portion, and an emission surface from which an incident light from the incident surface is emitted formed on the other end portion; and
a second light guide with a light incident surface upon which light emitted from the emission surface of the first light guide is incident formed on one end portion, and a light emission surface from which an incident light from the light incident surface is emitted formed on the other end portion,
wherein a reflective portion that internally reflects the incident light from the incident surface toward the emission surface is formed on the first light guide, and a diffusion processing portion that diffuses light is formed on the light incident surface of the second light guide,
an upper and a lower surface of the second light guide are inclined so as to gradually come closer together toward the light emission surface of the second light guide, and
the vertical thickness of the second light guide becomes thinner toward the light emission surface, so the area of the light emission surface is smaller than the area of the light incident surface.

8. The vehicular lamp according to claim 7, wherein the reflective portion includes curved reflective surfaces and steps.

9. The vehicular lamp according to claim 7, wherein a reflective coating is provided on an outer surface of the reflective portion.

10. The vehicular lamp according to claim 7, wherein:
the light sources emit light upward;
a lower surface of the first light guide is formed as the incident surface, and is positioned opposing the light sources;
a rear surface of an upper end portion of the first light guide is formed as the emission surface;
the reflective portion is formed on the first light guide, in a position in front of the emission surface;
the second light guide is arranged to a rear of the first light guide;
a front surface of the second light guide is formed as the light incident surface, and is positioned opposing the emission surface; and
a rear surface of the second light guide is formed as the light emission surface.

11. The vehicular lamp according to claim 10, wherein:
the reflective portion diffuses light in a lateral direction on the vehicular lamp; and
the diffusion processing portion diffuses light in a vertical direction of the vehicular lamp.
